(19) United States
(12) Patent Application Publication
(10) Pub. No.: US 2026/0065734 A1
(43) Pub. Date: Mar. 5, 2026

(54) ENHANCEMENTS FOR LOW-TOUCH BIOMETRIC SYSTEMS

(71) Applicant: Secure Identity, LLC, New York, NY (US)

(72) Inventors: Vladimir Stojkovski, New York, NY (US); Jeff Valeo, New York, NY (US); Connie Ko, New York, NY (US); Austin Puckett, New York, NY (US); Raymond Protasiewicz, New York, NY (US)

(21) Appl. No.: 19/379,738

(22) Filed: Nov. 4, 2025

Related U.S. Application Data
(60) Provisional application No. 63/457,117, filed on Apr. 4, 2023.

(51) Int. Cl. G07C 9/37; G06F 21/45; G06V 40/16; G06V 40/40

(52) U.S. Cl. CPC G07C 9/37; G06F 21/45; G06V 40/161; G06V 40/45

(57) ABSTRACT

In various embodiments, enhancements for low-touch biometric systems include obtaining winnowing information when a biometric probe unsuccessfully matches against a subset gallery. The winnowing information is used to obtain biometric data from an associated group of people and the biometric probe is then compared against the biometric data. If this also fails, identity information may be obtained and used to obtain a corresponding biometric template to match the biometric probe against. In some embodiments, enhancements for low-touch biometric systems determining a dominant by selecting the largest live face in an image then performing one or more actions using the dominant. Such one or more actions may include selecting the dominant for capture, performing exposure control and/or gain control on the dominant as opposed to the rest of an image, determining guidance to provide for biometric capture based at least on a position of the dominant, providing such guidance, etc.

### FIELD

The described embodiments relate generally to biometric systems. More particularly, the present embodiments relate to enhancements for low-touch biometric systems.

### BACKGROUND

Biometric identification systems may identify people using biometrics. Biometrics may include fingerprints, palm prints, irises, eyes, faces, voices, gaits, pictures, or other identifying characteristics about a person. A biometric identification system may capture information about a biometric using a biometric reader and identify a person by comparing the captured information against stored information. For example, an image sensor may capture an image of a fingerprint and compare the image of the fingerprint against stored fingerprint images.

### SUMMARY

The present disclosure relates to enhancements for low-touch biometric systems. In various embodiments, winnowing information is obtained when a biometric probe unsuccessfully matches against a subset gallery. The winnowing information is used to obtain biometric data from an associated group of people and the biometric probe is then compared against the biometric data. If this also fails, identity information may be obtained and used to obtain a corresponding biometric template to match the biometric probe against. In some embodiments, a dominant may be determined by selecting the largest live face in an image then performing one or more actions using the dominant. Such one or more actions may include selecting the dominant for capture, performing exposure control and/or gain control on the dominant as opposed to the rest of an image, determining guidance to provide for biometric capture based at least on a position of the dominant, providing such guidance, and so on.

In various embodiments, a system includes at least one non-transitory storage medium that stores instructions and at least one processor. The at least one processor executes the instructions to obtain at least one biometric probe from at least one person; unsuccessfully attempt to match the at least one biometric probe from the at least one person to at least one subset biometric gallery derived from at least one storage biometric gallery; obtain winnowing information; use the winnowing information to obtain biometric data for a group of people associated with the winnowing information in the at least one storage biometric gallery; unsuccessfully attempt to match the at least one biometric probe from the at least one person to the biometric data for the group of people; obtain identity information associated with the at least one person; use the identity information to obtain a biometric template associated with the identity information in the at least one storage biometric gallery; and, upon determining a match within a match threshold between the at least one biometric probe for the at least one person and the biometric template, perform at least one action.

In some examples, the action includes determining to allow the person to enter at least one area. In a number of examples, the action includes operating at least one electronic gate. In various examples, the winnowing information is obtained from at least one boarding pass, ticket, or identification document. In some examples, the identity information includes at least one of a phone number, an email address, a name, a date of birth, or a barcode. In various examples, the identity information is used to look up an account associated with the biometric template. In some examples, the group of people includes multiple people. In some examples, the at least one subset biometric gallery is smaller than the at least one storage biometric gallery and the biometric data for the group of people is smaller than the at least one subset biometric gallery. In a number of examples, the at least one biometric probe corresponds to at least one face.

In some embodiments, a system includes at least one non-transitory storage medium that stores instructions and at least one processor. The at least one processor executes the instructions to obtain image sensor data; determine a largest face included in the image sensor data; determine whether the largest face is live; upon determining that the largest face is live, determine that the largest face is dominant; upon determining that the largest face is live, determine that a next largest face included in the image sensor data that is live is the dominant; and perform at least one action using the dominant.

In various examples, the at least one action includes generating at least one biometric probe for the dominant and performing at least one biometric comparison using the at least one biometric probe. In some examples, the at least one action includes overlaying at least one reticle corresponding to the dominant in the image sensor data and displaying the image sensor data with the at least one reticle. In various implementations of such examples, the at least one action further includes tracking the dominant in subsequent image sensor data, updating the at least one reticle for movement of the dominant in the subsequent image sensor data to generate at least one updated reticle, and displaying the subsequent image sensor data with the updated at least one reticle.

In some examples, the at least one action includes performing at least one of exposure control or gain control on the dominant in the image sensor data. In a number of implementations of such examples, the at least one action further includes omitting performing the at least one of the exposure control or the gain control on portions of the image sensor data other than the dominant in the image sensor data. In various implementations of such examples, performing the at least one of the exposure control or the gain control on the dominant in the image sensor data includes generating at least one box around the dominant and performing the at least one of the exposure control or the gain control on an area of the image sensor data within the at least one box.

In a number of embodiments, a method includes determining a dominant by determining a largest, live face included in image sensor data; generating at least one biometric probe for the dominant; unsuccessfully attempting to match the at least one biometric probe from the at least one person to at least one subset biometric gallery derived from at least one storage biometric gallery; using winnowing information to obtain biometric data for a group of people associated with the winnowing information in the at least one storage biometric gallery; unsuccessfully attempting to match the at least one biometric probe to the biometric data for the group of people; using the identity information to obtain a biometric template associated with the identity information in the at least one storage biometric gallery; and upon determining a correspondence between the at least one biometric probe and the biometric template, performing at least one action.

In various examples, the method further includes obtaining the image sensor data using at least one application specific processor of at least one camera. In some examples, the group is empty. In a number of examples, the method further includes upon determining that the at least one biometric probe and the biometric template do not match, perform at least one alternative action.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example enhanced low-touch biometric system.

FIG. 2 is a flow chart illustrating a first example method for enhancing low-touch biometric systems. The method may be performed by the system of FIG. 1.

FIG. 3 is a flow chart illustrating a first example method for enhancing low-touch biometric systems. The method may be performed by the system of FIG. 1.

FIG. 4 is a flow chart illustrating a second example method for enhancing low-touch biometric systems. The method may be performed by the system of FIG. 1.

FIG. 5 is a flow chart illustrating a third example method for enhancing low-touch biometric systems. The method may be performed by the system of FIG. 1.

FIG. 6A depicts an example user interface.

FIG. 6B depicts the example user interface after movement.

FIG. 6C depicts the example user interface after a person reaches a capture volume.

FIG. 6D depicts the example user interface with active text banner feedback.

FIG. 7 is a flow chart illustrating a fourth example method for enhancing low-touch biometric systems. The method may be performed by the system of FIG. 1.

FIG. 8 is a flow chart illustrating a fifth example method for enhancing low-touch biometric systems. The method may be performed by the system of FIG. 1.

FIG. 9 depicts example relationships between example components that may be used to implement the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

Embodiments discussed herein may generally apply to two types of biometric matching, namely “verification” matching and “identification” matching. Verification matches may be made to determine a person's identity from among a group of known people culled from a larger pool, while identification matches may be made to determine an individual's identity from the larger pool itself (e.g., rather than against a subset of the pool, as in verification).

Verification may assume knowledge of the person presenting themselves, and may verify his or her identity using biometric matching. This process may use a small number of potential matches, as the verification process itself may deeply narrow down the potential matching candidates in advance. This is referred to as 1-to-1 or 1-to-few matching, where “few” may mean a relatively small pool of potential candidates to match against, such as less than 20. Verification may be a useful biometric matching solution when there is some knowledge introduced at the exact time of the biometric match, like an identification card with a name or other personal identifier.

In these cases, a workflow may include a) presenting an identification token with a personal identifier on it, b) reading the personal identifier and querying a biometric repository to identify potential matches, c) performing a biometric match against the returned potential matches, and d) responding with a match result. One example of this type of use may be when a person puts their ATM card in a bank machine, and the bank ATM then takes a photo of their face and compares it to the registered face associated with the accounts associated with the presented ATM card. In that case, the facial recognition matching is only comparing the photo to the faces associated with that account, not all faces for all accounts registered at that bank.

Identification may assume no advanced knowledge of who is presenting themselves to be identified. This process may be referred to as 1-to-many or 1-to-n. Identification operations may be much more complex than verification operations, as they may rely on using the biometrics themselves, and they may search against the entire gallery of enrolled individuals, which may measure into the hundreds of millions of identities.

The process of doing 1-to-many identifications against a group of biometrically enrolled individuals may consist of the following steps:

1. Build a “gallery” of enrollment templates. A gallery may be a set of biometric templates for enrolled individuals. Each template may be associated with an enrolled identity. A template may be a binary string that is produced by running an algorithm against a biometric image (e.g., fingerprint, iris, face, and so on).

2. Place the gallery in an infrastructure that has a matching algorithm. If the gallery size is large, this infrastructure may be very large, as measured by the number of servers or core processes that may run in parallel to handle large gallery size or concurrent identification requests.

3. As probe images are sent to the matching infrastructure, the matching algorithm may attempt to find an identity within some acceptable matching threshold. A probe image may be an image taken at the time an individual is to be biometrically identified. It may be turned into a probe template using the same or similar logic to create gallery templates, and that probe template may be introduced to the matching algorithm and may produce match results.

Challenges to overcome with biometric matching solutions may include 1) accuracy, 2) latency, and 3) throughput.

Accuracy may be determined by a measure of False Positive Rate (FPR) and False Negative Rate (FNR). A given matching algorithm may have defined rates of these measures, and they may be variable based on the number of templates in the gallery. As the gallery grows, it may be challenging to keep the accuracy stable, perhaps even high.

Latency may mean the time it takes for a single identification operation, and throughput may mean how many identifications can be done within a given period of time. A given matching algorithm may be optimized for (or may generally address) one or both of these measures.

Some biometrics, by their very nature, may be faster or more accurate than others. Likewise, some biometrics may be slower or less accurate than others. Entities that choose to implement biometric identification may take many factors into account as to which biometrics they want to consider.

Some major factors to consider may include importance of accurate identification, user experience, timeliness of response, and cost of infrastructure.

More mature and “high-touch” biometric matching solutions, like fingerprints and irises, may deliver high accuracy and speed with smaller cost to infrastructure, but may deliver such results at the expense of user experience. The biometrics may operate within a well-defined set of quality and acceptance criteria, and the biometric capture devices may be specialized to capture only good images under ideal sets of conditions.

Newer “low-touch” biometric matching solutions, like facial recognition, may deliver a very desirable user experience, but may deliver such at the cost of accuracy, speed, and cost to infrastructure. The biggest challenge with some of the “low-touch” biometric matching solutions may be that they are impacted by many more external factors that may impact results, lighting for facial recognition, for example. The combination of both less mature matching algorithms as well as the high level of deviation of biometric images for the same identity because of external conditions may lead to a significant impact in both accuracy and speed for these “low-touch” biometrics. This accuracy drop-off may become very relevant as the size of the gallery grows. In some facial recognition matching algorithms, a gallery size of 50,000 may be where accuracy begins to degrade dramatically to the point of becoming useless. This may be extremely limiting when a desired gallery size of 100 million is desired for an identification operation.

In order to improve accuracy, latency, and/or throughput, the present disclosure may generate one or more subset galleries from the gallery, which may be designated the “storage gallery.” Such a storage gallery may store a portion of the digital representations of biometrics and/or other biometric information stored by the storage gallery. As such, performing biometric matching against the subset gallery may be more accurate, lower latency, and/or higher throughput than matching against the storage gallery. Biometric matching against the subset gallery that is unsuccessful may failover into matching against the storage gallery (and/or one or more subset galleries where one or more subset galleries are created, such as different subsets of the storage gallery).

The subset gallery may be stored in a storage device that is faster to access than the storage gallery, such as on a more quickly accessible storage device (such as on a memory or cache versus a hard drive or other longer term storage), on a closer device that has less network latency and/or does not require network communication (such as on a device that performs the biometric matching versus one or more servers and/or server allocations with which the device that performs the biometric matching communicates), and so on. In such a situation, the subset gallery may be a “local” gallery. Alternatively, the subset gallery and storage gallery may be stored on the same storage device and/or device and the improvement to accuracy, latency, and/or throughput may come from performing biometric matching against the relatively smaller size of the subset gallery versus the storage gallery.

In the context of this disclosure, terms such as “biometric information,” “biometric data,” “information about biometrics,” “data regarding biometrics,” and/or similar terms may refer to any kind of information related to biometrics. This may include, but is not limited to, full and/or partial images of biometrics, digital representations of biometrics, hashes, encodings of biometrics, and/or any other digital or other data structure that may indicate and/or store information regarding one or more biometrics.

In some implementations, the storage gallery may be quite large. For example, the storage gallery may contain biometric information related to millions of individuals, such as 2 million, 7 million, and so on. With facial recognition or similar low-touch biometric techniques, matching against such a large population may simply not be feasible. For example, accuracy with such a population size may simply not be possible, not to mention the corresponding increase in latency and/or hardware and/or software resource consumption. False positive and/or false negative rates may rise above acceptable limits when the population is above a few thousand, and a population multiple million may make such biometric techniques simply unworkable. In such situations, creating one or more subset galleries with biometric information for a smaller population (such as a few thousand) as opposed to the larger population of the storage gallery (such as a few million) may make use of some biometric techniques possible as well as improving latency, reducing hardware and/or software resource consumption, and so on.

The higher the chance that a subset gallery includes biometric data for a person upon whom biometric comparison is performed, the more effective that subset gallery would be over the storage gallery. In order to assemble such a subset gallery, it would be advantageous to determine who and who is not present and/or will be present for biometric comparison.

However, the likelihood of assembling a perfect subset gallery is extremely small. No matter how effective the subset gallery is, situations where the subset gallery does not include corresponding biometric data must still be handled. For low-touch biometrics, it is simply infeasible to failover to compare against the storage gallery as the accuracy would fall too low, latency would increase too much, and rates of false positives and/or false negatives would increase beyond acceptable ranges.

In order to ameliorate such issues, winnowing information may be obtained when a biometric probe unsuccessfully matches against a subset gallery. The winnowing information may be used to obtain biometric data from an associated group of people and the biometric probe may then be compared against the biometric data. If this also fails, identity information may be obtained and used to obtain a corresponding biometric template to match the biometric probe against. In this way, subset gallery comparison failures may be handled without resorting to direct comparison against the storage gallery, resulting in increased accuracy as well as decreased latency, false positives, and/or false negatives. This technological solution to the technological problem of subset gallery failure enables devices of a biometric system using such techniques to operate more efficiently while using less hardware and/or software resources.

Additionally, the accuracy and latency of low-touch biometric systems is also closely tied to the quality of biometrics. The quality of low-touch biometrics like facial recognition may be complicated by issues like multiple faces in images, proper positioning of people to biometric reader devices, sensor data quality, and so on. To ameliorate such issues for low-touch biometrics like facial recognition, a dominant may be determined by selecting the largest live face in an image then performing one or more actions using the dominant. Such one or more actions may include selecting the dominant for capture, performing exposure control and/or gain control on the dominant as opposed to the rest of an image, determining guidance to provide for biometric capture based at least on a position of the dominant, providing such guidance, and so on. These techniques may improve biometric capture, which in turn may improve the operation of devices of a biometric system by improving accuracy and quality, reducing latency as well as false positives and/or negatives, reducing the consumption of hardware and/or software resources by minimizing the number of recapturing that may need to be performed as well as simplifying biometric comparison, and so on.

The present disclosure relates to enhancements for low-touch biometric systems. In various embodiments, winnowing information is obtained when a biometric probe unsuccessfully matches against a subset gallery. The winnowing information is used to obtain biometric data from an associated group of people and the biometric probe is then compared against the biometric data. If this also fails, identity information may be obtained and used to obtain a corresponding biometric template to match the biometric probe against. In some embodiments, a dominant may be determined by selecting the largest live face in an image then performing one or more actions using the dominant. Such one or more actions may include selecting the dominant for capture, performing exposure control and/or gain control on the dominant as opposed to the rest of an image, determining guidance to provide for biometric capture based at least on a position of the dominant, providing such guidance, and so on.

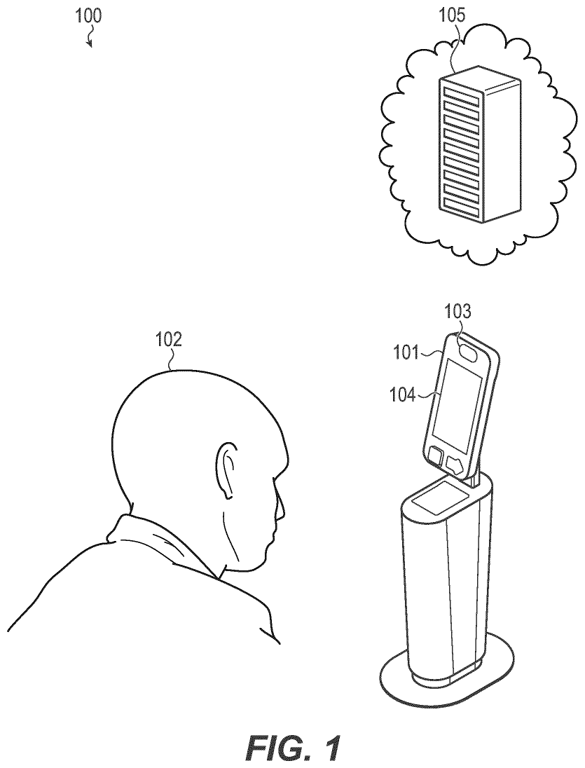

These and other embodiments are discussed below with reference to FIGS. 1-9. However, those skilled in the art will readily appreciate that the detailed description given herein with respect to these Figures is for explanatory purposes only and should not be construed as limiting.

FIG. 1 depicts an example enhanced low-touch biometric system. The system 100 may include one or more biometric devices 101 that may be operable to communicate with one or more biometric system devices 105. For example, the biometric device 101 may be a biometric station that is operable to obtain one or more biometric probes from one or more people 102 and compare such against one or more subset galleries. The biometric device 101 may include one or more input and/or output devices, such as one or more biometric reader devices 103 (like one or more cameras and/or other image sensors), one or more displays 104, and so on. Further, the biometric system device 105 may be a server that stores and/or provides access to one or more storage galleries from which the subset gallery is derived.

As discussed above, the likelihood of assembling a perfect subset gallery is extremely small and no matter how effective the subset gallery is, situations where the subset gallery does not include corresponding biometric data must still be handled. In order to ameliorate these issues, the system 100 may obtain winnowing information when a biometric probe (such as one or more images of one or more faces) unsuccessfully matches against the subset gallery. The winnowing information may be used to obtain biometric data from an associated group of people (such as from the storage gallery) and the biometric probe may then be compared against the biometric data. If this also fails, identity information may be obtained and used to obtain a corresponding biometric template (such as from the storage gallery) to match the biometric probe against. In this way, subset gallery comparison failures may be handled without resorting to direct comparison against the storage gallery, resulting in increased accuracy as well as decreased latency, false positives, and/or false negatives. This technological solution to the technological problem of subset gallery failure enables devices of a biometric system using such techniques to operate more efficiently while using less hardware and/or software resources.

The group of people may be an empty group or a nonempty group, such as a group that includes only one person or a group that includes multiple people. The winnowing information may be information that is indicative of identity, but may not uniquely identify a person and/or even be particularly trustworthy.

For example, the winnowing information may be “self-attested” in the fact that the only indicator that the winnowing information is truly associated with the person who presents the winnowing information is the fact that the person who presents the winnowing information is presenting such as associated with themselves.

By way of illustration, the person 102 may present one or more winnowing items (such as a physical or digital (such as displayed on a mobile and/or portable electronic device) ticket, a boarding pass or other document, an identification card, and so on) and the biometric device 101 may scan, capture an image of, read, enter, and/or otherwise obtain the winnowing information from the winnowing item. The winnowing information may then be used to obtain biometric data from an associated group of people and the biometric probe may be compared against the biometric data.

The winnowing information may be compared against stored information to identify the group of people. Such a comparison may be a fuzzy matching comparison in order to ensure that a sufficient number of people who might be the person presenting the winnowing information are included such that the person 102 is included in the group of people. Fuzzy matching, also known as approximate string matching, is a technique used to find strings and/or other information sequences that are similar but not necessarily identical to a target string and/or other information sequence. For example, fuzzy matching may be used to include in the group of people a first person named “Frank Jones” and a second person “Frank Jonas” when winnowing information “Frank Jones” is presented in order to compensate for the possibility that the winnowing information was misspelled, truncated, inaccurate, or mismatched.

In some examples, the winnowing information may be used to generate both the subset gallery and the biometric data for the associated group of people. By way of illustration, winnowing information may be obtained from people entering a biometric line and used to generate the subset gallery from the storage gallery. However, because the subset gallery in this example is generated using the winnowing information from all people entering the biometric line and the biometric data for the associated group of people is generated only from the winnowing information from the person 102, the biometric data for the associated group of people is likely to be considerably smaller than the subset gallery, allowing for increased accuracy and lower latency for comparisons.

The identity information may be one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like), barcodes (such as one or more quick response codes), and so on associated with the identities of people (which may be verified identities, where the identities are verified as corresponding to the particular person named and/or where the identity information is verified as valid). The identity information may be associated with one or more identities, which in turn may be associated with one or more stored biometric templates.

In some examples, the identity information may be used to select and present a list of possible identities. The person 102 may then select from the list of possible identities in order to obtain a particular biometric template to compare the biometric probe against. In this way, the biometric probe may be matched against a single biometric template. By way of illustration, the person 102 may use an app on a mobile device to display a quick response code for their account, which may be scanned by the biometric device 101 in order to display their account that they may then select. This may be an even smaller amount of biometric information than the biometric data for the associated group of people, allowing for even more increased accuracy and lower latency for comparisons.

Upon matching the biometric probe within a matching threshold (such as within 0.2%) to the subset gallery, the biometric data for the associated group of people, and/or the biometric template, the biometric device 101 may perform one or more actions. For example, based on at least one permission associated with a matched identity, the biometric device 101 may allow the person 102 to enter an area. By way of illustration, the biometric device 101 may operate at least one electronic gate to allow the person 102 to enter the secured area at airport, venue, business, residence, and so on.

However, if the system 100 is unable to match the biometric probe to the subset gallery, the biometric data for the associated group of people, and/or the biometric template, the system 100 may perform one or more alternative actions. By way of illustration, in some examples, the system 100 may be able to allow a person access upon presentation of an identification document. By way of another illustration, in various examples, the system 100 may inform a person that they will be unable to use a biometric line associated with the system 100 and will need to seek an alternative screening line. Various configurations are possible and contemplated without departing from the scope of the present disclosure.

Additionally, the accuracy and latency of low-touch biometric systems are also closely tied to the quality of biometrics. The quality of low-touch biometrics like facial recognition may be complicated by issues like multiple faces in images, proper positioning of people to biometric reader devices, sensor data quality, and so on. To ameliorate such issues for low-touch biometrics like facial recognition, the system 100 may determine a dominant by selecting the largest live face in an image then performing one or more actions using the dominant. Such one or more actions may include selecting the dominant for capture, performing exposure control and/or gain control on the dominant as opposed to the rest of an image, determining guidance to provide for biometric capture based at least on a position of the dominant, providing such guidance, and so on. These techniques may improve biometric capture, which in turn may improve the operation of devices of a biometric system by improving accuracy and quality, reducing latency as well as false positives and/or negatives, reducing the consumption of hardware and/or software resources by minimizing the number of recapturing that may need to be performed as well as simplifying biometric comparison, and so on.

By way of explanation, the biometric device 101 may obtain camera and/or other image sensor data using the biometric reader device 103. The camera and/or other image sensor data may be video, one or more still images, and so on. A number of faces may be present in the camera and/or other image sensor data. For example, the biometric device 101 may be used to obtain one or more biometric probes associated with one or more faces. However, a number of faces may be present, such as where the person 102 is in a line with one or more other people in an area that may be captured by the biometric device 101 (such as people behind the person 102 in line, children or other people with the person 102, one or more babies held by the person 102, people present around the line, and so on). In order to determine which face in the camera and/or other image sensor data to take one or more actions regarding, the system 100 may determine which face is dominant.

In order to do this, the system 100 may determine which face in the camera and/or other image sensor data is largest. This would screen out other people around the line, people behind the person 102 in line, children or other people with the person 102, one or more people held by the person, and so on.

Upon determining the largest face in the camera and/or other image sensor data, the system 100 may determine whether or not the face is live. For example, one or more distance sensors may be used to determine whether or not the face is three dimensional. By way of illustration, the largest face in the camera and/or other image sensor data may be a face in a concert shirt worn by the person 102. Upon determining that the face on the shirt is the largest but is not live, the system 100 may determine the next largest face and whether or not the next largest face is live. Upon determining the largest live face, the system may determine that the largest live face is dominant and may perform one or more actions related to the dominant.

By way of example, the system 100 may generate at least one biometric probe for the dominant. The system 100 may then perform at least one biometric comparison using the at least one biometric probe.

By way of another example, the biometric reader device 103 may have an associated capture volume. This may be a volume within which one or more biometrics may be most effectively captured. Capturing one or more biometrics outside of this volume may result in lower quality biometrics, such as where one or more distortions are caused, inability to perform liveness detection and/or other operations, and so on. As such, the system 100 may provide feedback to the person 102 to guide the person 102 to position themselves appropriately within the capture volume. The dominant may be used to do this.

By way of illustration, at least one reticle may be overlayed corresponding to the dominant in the camera and/or other image sensor data. The camera and/or other image sensor data with the overlayed reticle may be presented, such as on the display 104. The system 100 may track the dominant in subsequent camera and/or other image sensor data, update the reticle for movement of the dominant in the subsequent camera and/or other image sensor data to generate an updated reticle, and display the subsequent camera and/or other image sensor data with the updated reticle. This may be used to guide the person into the capture volume. For example, the reticle may follow the person's face in the presented camera and/or other image sensor data and an amount that the person's face fills the reticle may be used to indicate whether the person is too close, too far, and so on. A color and/or other state of the reticle and/or other interfaces (such as one or more text boxes) also may be used to signal whether or not to move closer, to move further back, to move side to side, that camera and/or other image sensor data is about to be and/or has been captured, and so on.

In another illustration, the dominant may be used to perform actions like exposure control and/or gain control. Exposure control and/or gain control may be performed on all of the camera and/or other image sensor data, but this may be wasted effort and/or resources and/or not result in as optimal of gain control and/or exposure control when only the quality of a portion of the camera and/or other image sensor data (such as the area around the face of the person 102) is significant. As such, the determined dominant may be used to perform gain control and/or exposure control on only the portion of the camera and/or other image sensor data corresponding to the face of the person 102 while not performing such on other portions. By way of example, one or more boxes may be drawn around the dominant and gain control and/or exposure control may be performed on the one or more boxes. This may result in higher quality biometric probes, which may in turn increase accuracy, decrease latency, and so on for performing actions like biometric comparisons.

In various implementations, the biometric reader device 103 may include one or more application specific processors. The application specific processor may be configured to perform various operations like capturing images of one or more faces, determining liveness of one or more faces, determining the dominant, determining distance to one or more faces, obtaining camera and/or other image sensor data, and so on.

Although the system 100 is illustrated and described as including particular components arranged in a particular configuration, it is understood that this is an example. Other configurations of the same, similar, and/or different components are possible and contemplated without departing from the scope of the present disclosure.

For example, the system 100 illustrates and describes the biometric reader device 103 and the display 104 as integrated into the biometric device 101. However, it is understood that this is an example. In some implementations, such may be components of one or more different devices. Various configurations are possible and contemplated without departing from the scope of the present disclosure.

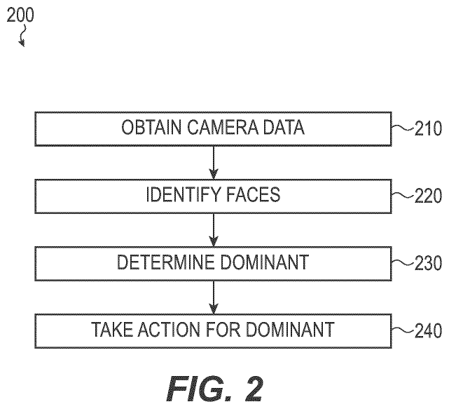

FIG. 2 depicts a first example method 200 for enhancing low-touch biometric systems. This first example method 200 may be performed by the system 100 of FIG. 1.

At operation 210, an electronic device (such as the biometric device 101 of FIG. 1, the biometric system device 105 of FIG. 1, and so on) may obtain camera data. The camera data may be one or more still images, video, and so on.

At operation 220, the electronic device may identify one or more faces in the camera data. Identification of the one or more faces may include analyzing one or more shapes in the camera data, analyzing relationships among the one or more shapes in the camera data, and so on.

At operation 230, the electronic device may determine a dominant from the one or more faces. Determining the dominant may include determining the largest face, determining a liveness of one or more of the one or more faces, and so on.

At operation 240, the electronic device may take one or more actions for the dominant. Such actions may include generating one or more biometric probes, performing one or more biometric comparisons, presenting one or more user interfaces related to the dominant, tracking the dominant, performing activities like gain control and/or exposure control, and so on.

In various examples, this example method 200 may be implemented using a group of interrelated software modules or components that perform various functions discussed herein. These software modules or components may be executed within a cloud network and/or by one or more computing devices, such as the biometric device 101 of FIG. 1, the biometric system device 105 of FIG. 1, and so on.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as involving camera data. However, it is understood that this is an example. In various implementations, image sensors other than cameras may be used. Various configurations are possible and contemplated without departing from the scope of the present disclosure.

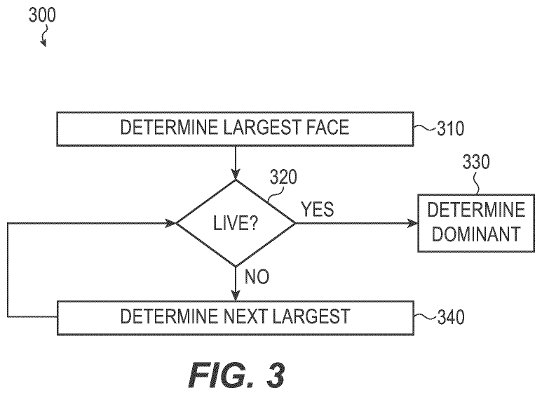

FIG. 3 depicts a second example method 300 for enhancing low-touch biometric systems. This second example method 300 may be performed by the system 100 of FIG. 1.

At operation 310, an electronic device (such as the biometric device 101 of FIG. 1, the biometric system device 105 of FIG. 1, and so on) may determine the largest face in camera and/or other image sensor data. A face may be the largest face by being the only face in the camera and/or other image sensor data, by being closer to the camera and/or other image sensor than other faces in the camera and/or other image sensor data, by actually being larger than other faces in the camera and/or other image sensor data, and so on.

At operation 320, the electronic device may determine whether or not the determined largest face is live. The face may be live if it is the face of a living person. The face may not be live if it is an image of the face of a person (such as a face on a concert shirt), shaped like a face but not actually a face, and so on. If so, the flow may proceed to operation 330. Otherwise, the flow may proceed to operation 340.

At operation 330, after the electronic device determines that the determined largest face is live, the electronic device may determine that the largest face that has been determined to be live is dominant.

At operation 340, after the electronic device determines that the determined largest face is not live, the electronic device may determine the next largest face. The flow may then return to operation 320 where the electronic device may determine whether or not the determined largest face is live.

In various examples, this example method 300 may be implemented using a group of interrelated software modules or components that perform various functions discussed herein. These software modules or components may be executed within a cloud network and/or by one or more computing devices, such as the biometric device 101 of FIG. 1, the biometric system device 105 of FIG. 1, and so on.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as determining the largest face and then whether or not that largest face is live. However, it is understood that this is an example. In various implementations, one or more of these operations may be omitted, replaced with other operations, and so on. For example, the dominant face may be selected as the face that is closest to a camera and/or other image sensor using one or more distance sensors. Various configurations are possible and contemplated without departing from the scope of the present disclosure.

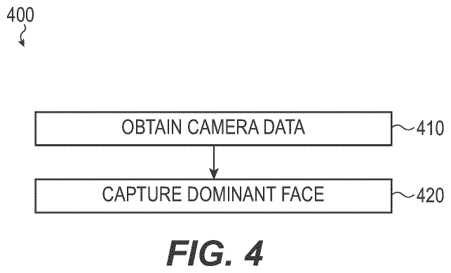

FIG. 4 depicts a third example method 400 for enhancing low-touch biometric systems. This third example method 400 may be performed by the system 100 of FIG. 1.

At operation 410, an electronic device (such as the biometric device 101 of FIG. 1, the biometric system device 105 of FIG. 1, and so on) may obtain camera data. The electronic device may obtain the camera data using one or more application specific processors included in one or more still images and/or video cameras.

At operation 420, the electronic device may capture a dominant face in the camera data. For example, the electronic device may determine that the dominant face is the largest face in the camera data that is live. Capturing the face determined to be dominant may include storing one or more images of the face.

In various examples, this example method 400 may be implemented using a group of interrelated software modules or components that perform various functions discussed herein. These software modules or components may be executed within a cloud network and/or by one or more computing devices, such as the biometric device 101 of FIG. 1, the biometric system device 105 of FIG. 1, and so on.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 is illustrated and described as capturing the dominant face. However, it is understood that this is an example. In various implementations, other actions may be performed related to the dominant face other than capturing the dominant face. Various configurations are possible and contemplated without departing from the scope of the present disclosure.

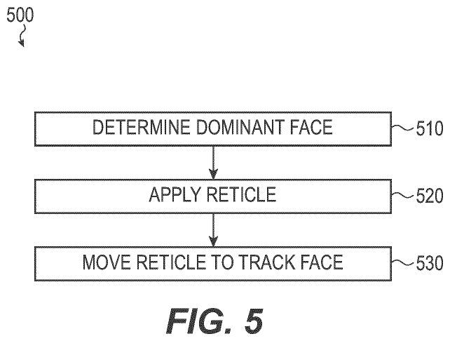

FIG. 5 depicts a fourth example method 500 for enhancing low-touch biometric systems. This fourth example method 500 may be performed by the system 100 of FIG. 1.

At operation 510, an electronic device (such as the biometric device 101 of FIG. 1, the biometric system device 105 of FIG. 1, and so on) may determine a dominant face in camera and/or other image sensor data. The dominant face may be the largest live face in the camera and/or other image sensor data.

At operation 520, the electronic device may apply one or more reticles to the dominant face. For example, applying the reticle may include overlaying the reticle over one or more images of the dominant face. The reticle may be circular, oval, rectangular, triangular, irregularly shaped, and so on.

At operation 530, the electronic device may move the reticle to track the dominant face. For example, the dominant face may be included in a sequential series of images. The position of the dominant face may move between these sequential series of images. As such, the electronic device may move the reticle in the sequential series of images such that the reticle follows the dominant face.

In various examples, this example method 500 may be implemented using a group of interrelated software modules or components that perform various functions discussed herein. These software modules or components may be executed within a cloud network and/or by one or more computing devices, such as the biometric device 101 of FIG. 1, the biometric system device 105 of FIG. 1, and so on.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 may include one or more additional operations. Such additional operations may include presenting or more images of the camera and/or other sensor data including the dominant face and the reticle. Such operations may guide a person to position themselves within a camera and/or other image sensor capture volume. Various configurations are possible and contemplated without departing from the scope of the present disclosure.

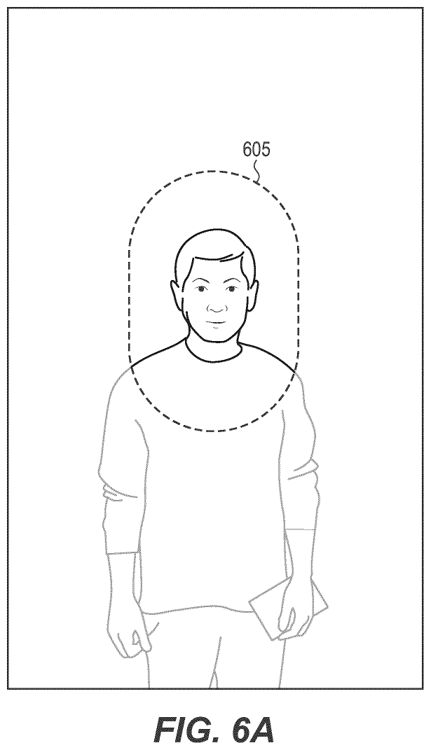

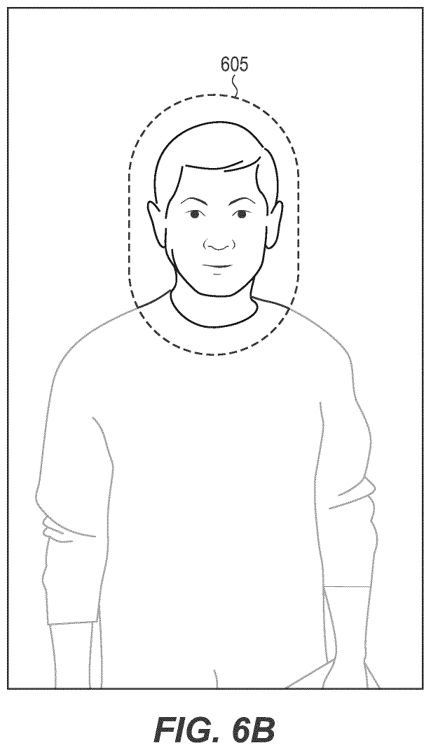

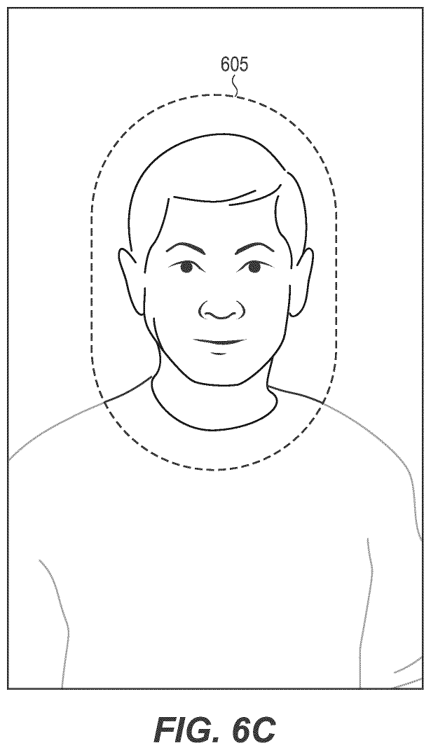

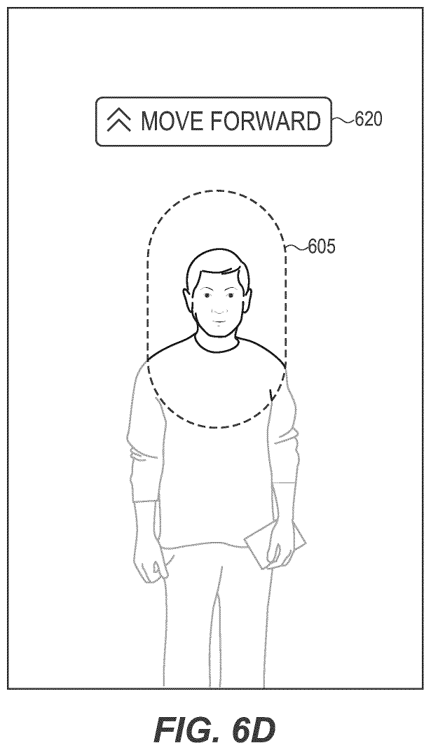

By way of illustration, FIGS. 6A-6D illustrate a user interface that may be used to guide a person to position themselves within a camera and/or other image sensor capture volume. A biometric device may capture one or more facial images of people and/or a portion thereof using one or more camera and/or other image sensors. The biometric device may have a capture volume, or a designated area with respect to the biometric device where the biometric device will attempt to capture the one or more facial images of the people using the using one or more camera and/or other image sensors. The capture volume may not be where people would naturally stand during biometric capture, such as where they would naturally stand closer. If the person is outside the capture volume, inaccuracies may be caused. As such, the biometric device may omit capturing facial images when people are outside the volume, avoid using any images captured outside of the capture volume, and so on. By way of illustration, perspective distortion may be caused when people are closer to the biometric device than the capture volume. Such perspective distortion may warp images of the people's faces and may make it more challenging for the biometric device to accurately measure the people. By way of another illustration, people being further from the biometric device than the capture volume may prevent operations, such as liveness detection where it may be determined whether or not facial images are captured from actual people as opposed to two-dimensional images held up in front of the one or more camera and/or other image sensors. Such operations may involve use of one or more proximity and/or other sensors (such as depth sensors, distance sensors, and so on), such as by detecting distances to people, and such sensors may not be as accurate when the distance to the people increases beyond certain limits (such as where the people are far enough from the biometric device that they are outside the capture volume. People being outside the capture volume may also cause privacy issues, such as where other people near the biometric device can view captured faces and/or otherwise interfere with the operation of the biometric device because people using the biometric device are outside the capture volume and thus are not blocking information displayed. Such a biometric device may provide guidance to people so assist the people in moving to position themselves within capture volume instead of too close, too far, and/or otherwise outside the capture volume.

FIG. 6A depicts a first example user interface. The first example user interface may be used to provide the guidance to people discussed above so assist the people in moving to position themselves within capture volume instead of too close, too far, and/or otherwise outside a capture volume.

The user interface may include a reticle 605 (or silhouette). The reticle 605 may be applied to one or more images of a person, such as video captured of the person that is then displayed with the reticle to provide guidance to the person. The reticle 605 may be applied such that the reticle is applied with respect to the person's face in the one or more images of the person and a capture volume.

For example, reticle 605 may be applied at the height of the person's face in the one or more images. This may enable providing guidance with respect to the person's face regardless of the person's particular height, whether the person is sitting or standing, whether or not the person is using a mobility assistance device, and so on. As the reticle 605 may be applied based on at least one of the positions of the person's face in the one or more images, the person may not have to move to align their face with the reticle 605.

The relationship between the edges of the reticle 605 and the person's face may correspond to the person's relationship to a capture volume. For example, the closer a person becomes to the capture volume, the smaller the distance may become between the edges of the reticle 605 and the person's face. Conversely, the further a person goes from the capture volume, the greater the distance may become between the edges of the reticle 605 and the person's face. Similarly, the edges of the reticle 605 may go beyond the person's face when the person exceeds the capture volume and the amount that the edges of the reticle go beyond the person's face may be proportional to the amount that the person has exceeded the capture volume. In this way, the person may see from the relationship between the reticle 605 and their face whether to move forward or back, as well as how much. Once the person is within the capture volume, a digital representation of a biometric (such as a facial image, a retina image, an iris image, and so on) may be captured.

As shown in FIG. 6A, there is space between the reticle 605 and the person's face within the reticle 605, indicating that the person should move forward to approach the capture volume. FIG. 6B depicts the first example user interface after movement. As shown, the space between the reticle 605 and the person's face within the reticle 605 has decreased, indicating that the person has moved forward to approach the capture volume. FIG. 6C depicts the first example user interface after the person reaches the capture volume.

In some implementations, a display associated with the user interface may be configured to be a portrait orientation with a mirrored video and/or image feed. This may ensure people of various heights are able to see themselves clearly on the display in real time. An associated camera or other image sensor field of view may similarly be portrait oriented to capture the full height range of people. The portrait-oriented display and field of view of the camera or other image sensor may provide an interface very similar to a mirror, a familiar and intuitive mental model.

The reticle 605 may follow the most dominant face within a camera or other image sensor capture zone. Face dominance may be determined by the closest face that is positioned with a specified head pose threshold. This may communicate to the person and any attendant of an associated biometric device the face that the system is targeting. During capture the reticle 605 may be designed to remain a static predetermined size, so that as people approach their face increasingly fills the shape. The reticle 605 size may be calibrated so that when a person with an average size face approaches a minimum capture distance threshold, their face may fully fill the reticle 605. If the person approaches closer than this distance the reticle 605 perimeter may begin to noticeably obstruct their face, encouraging the person to move backward within the capture range. If a person were to be positioned too far away, the person's face may appear small within the reticle 605, encouraging the person to continue to approach. This interface may draw parallels from existing mental models of face cutout photo boards used at events, carnivals and theme parks.

To further influence person's approach distance, the user interface may use other indicator elements to communicate as the person approaches or leaves the intended capture volume. For example, the user interface may utilize color change of the reticle 605 (or another state change) between a first color (white) and a second color (green) to communicate as the person approaches or leaves the intended capture volume. In one example, as the person approaches a defined distance (or distance range and so on) the reticle 605 outline may progressively or systematically change state (as shown in FIG. 6C) from white to green, reaching full green color when the person reaches the defined distance or distance range. Similarly in this example, if the person approaches too close the reticle 605 may begin to fade to white as the person continues to move toward the camera. Similarly in this example, if a person were to approach from the side and step into frame too close, the reticle 605 may be white and fade to green as the person moves back toward the defined capture zone.

In addition to the state change, the system may utilize active text banner feedback to provide instructions to move closer or further, in conjunction with the aforementioned interface elements. These text banners may track closely to the reticle 605 as opposed to a static location on screen. This may make the banners more noticeable as people may tend to focus on their own faces. The text may generally track to the top of the reticle 605, based on testing what people may experience as more noticeable. However, when a person is very tall or approaches the camera very close, if the text banner cannot fit within the frame above their head, it automatically may move to below the head so it may still be read. An example of active text banner feedback 620 is shown in FIG. 6D.

The user interface may also modify the area outside the reticle 605 and/or within the reticle 605 in order to draw the person's attention to the area within the reticle 605. For example, as shown, the area around the reticle 605 may be blurred while the area within the reticle is not blurred. However, it is understood that this is an example and that other modifications may be performed in order to order to draw the person's attention to the area within the reticle 605 and/or for other purposes without departing from the scope of the present disclosure.

Further, the reticle 605 is shown as an oval or a pill. However, it is understood that this is an example. In various implementations, other shapes, marks, and/or other indicators may be used without departing from the scope of the present disclosure.

The above describes applying the reticle 605 based at least on a relationship between a person and a capture volume as well as a position of the person's face in one or more images. Such positions may be determined by analyzing the one or more images, using one or more sensors, such as proximity sensors, depth sensors, distance sensors, and so on, or the like. Various configurations are possible and contemplated without departing from the scope of the present disclosure.

The above may be used to guide people to various portions of the capture volume. For example, the above may direct the person to a middle of the capture volume instead of one of the edges to lower the possibility that ordinary movement of the person may take him or her outside of the capture volume during biometric capture. Various configurations are possible and contemplated without departing from the scope of the present disclosure.

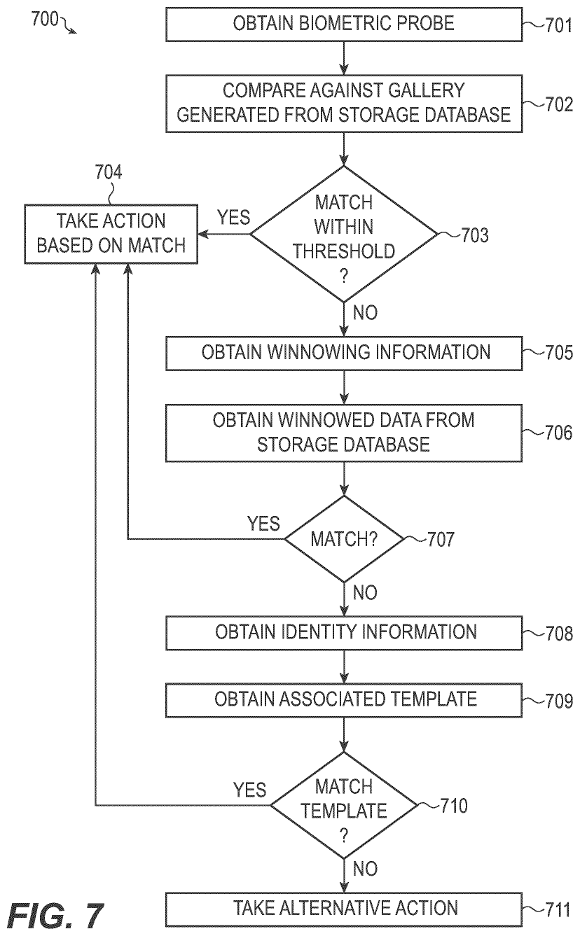

FIG. 7 depicts a sixth example method 700 for enhancing low-touch biometric systems. This sixth example method 700 may be performed by the system 100 of FIG. 1.

At operation 701, an electronic device (such as the biometric device 101 of FIG. 1, the biometric system device 105 of FIG. 1, and so on) may obtain one or more biometric probes. The biometric probe may be captured by obtaining data regarding one or more biometrics of one or more people, such as one or more facial images.

At operation 702, the electronic device may compare the biometric probe against a gallery generated from a storage database. The gallery may be a subset of the storage database. The gallery may be generated by copying biometric information for a group of people expected to present themselves for biometric comparison to the gallery from the storage database.

At operation 703, the electronic device may determine whether or not the biometric probe matches the gallery within threshold. If so, the flow may proceed to operation 704 where the electronic device may take one or more actions (such as allowing the person entrance, charging the person for an item, and so on) based on the match. Otherwise, the flow may proceed to operation 705.

At operation 705, the electronic device may obtain winnowing information. At operation 706, the electronic device may obtain winnowed data from the storage database using the winnowing information. The winnowing data may include biometric data for a group of people.

At operation 707, the electronic device may determine whether or not the biometric probe matches the winnowed data within threshold. If so, the flow may proceed to operation 704 where the electronic device may take one or more actions (such as allowing the person entrance, charging the person for an item, and so on) based on the match. Otherwise, the flow may proceed to operation 708.

At operation 708, the electronic device may obtain identity information. At operation 709, the electronic device may use the identity information to obtain an associated template. The associated template may be associated with the identity information in the storage database.

At operation 709, the electronic device the electronic device may determine whether or not the biometric probe matches the associated template within threshold. If so, the flow may proceed to operation 704 where the electronic device may take one or more actions (such as allowing the person entrance, charging the person for an item, and so on) based on the match. Otherwise, the flow may proceed to operation 709 where the electronic device may take one or more alternative actions, such as prompting a person for identification, presenting an error message, and so on.

In various examples, this example method 700 may be implemented using a group of interrelated software modules or components that perform various functions discussed herein. These software modules or components may be executed within a cloud network and/or by one or more computing devices, such as the biometric device 101 of FIG. 1, the biometric system device 105 of FIG. 1, and so on.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as performing an alternative action. However, it is understood that this is an example. In various implementations, the electronic device may keep requesting information until a biometric template that matches the biometric probe within a match threshold associated with the information can be located. Various configurations are possible and contemplated without departing from the scope of the present disclosure.

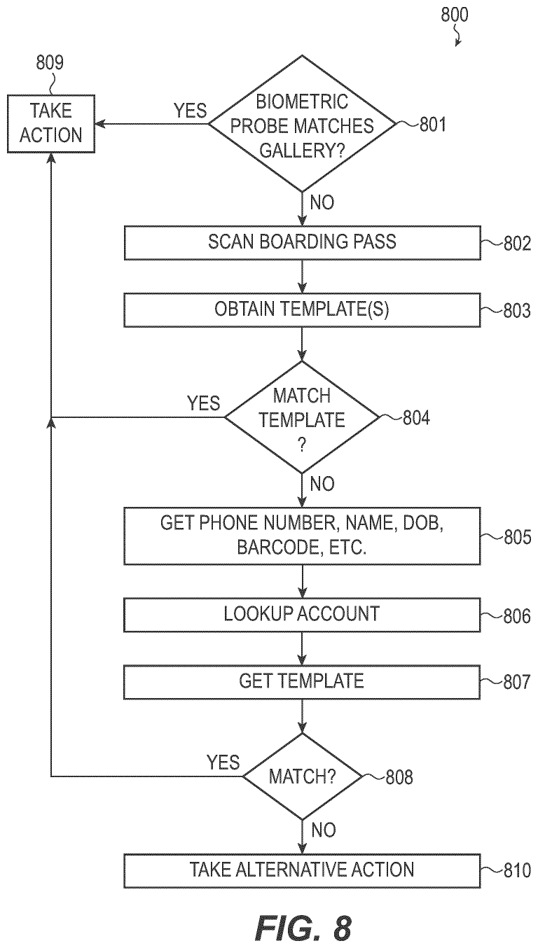

FIG. 8 depicts a seventh example method 800 for enhancing low-touch biometric systems. This seventh example method 800 may be performed by the system 100 of FIG. 1.

At operation 801, an electronic device (such as the biometric device 101 of FIG. 1, the biometric system device 105 of FIG. 1, and so on) may determine whether or not a biometric probe matches a gallery. The gallery may be derived from a master gallery in response to each person entering a screening line scanning a boarding pass. If so, the flow may proceed to operation 809 where the electronic device may perform an action. Otherwise, the flow may proceed to operation 802.

At operation 802, the electronic device may scan a boarding pass. At operation 803, the electronic device may obtain one or more biometric templates associated with a group of people associated with information scanned from the boarding pass. The group may be empty, may include information for one person, or may include information for multiple people.

At operation 804, the electronic device may determine whether or not the biometric probe matches one or more of the biometric templates. If so, the flow may proceed to operation 809 where the electronic device may perform an action. Otherwise, the flow may proceed to operation 805.

At operation 805, the electronic device may get one or more of a phone number, a name, a date of birth, a barcode, and so on. At operation 806, the electronic device may use the one or more of a phone number, a name, a date of birth, a barcode, and so on to lookup one or more accounts. For example, the electronic device may present a list and/or other structure of one or more accounts and allow selection of one of the presented one or more accounts.

At operation 807, the electronic device may get a biometric template associated with one of the accounts. At operation 808, the electronic device may determine whether or not the biometric probe matches the biometric template. If so, the flow may proceed to operation 809 where the electronic device may perform an action. Otherwise, the flow may proceed to operation 810 where the electronic device may take one or more alternative actions.

In various examples, this example method 800 may be implemented using a group of interrelated software modules or components that perform various functions discussed herein. These software modules or components may be executed within a cloud network and/or by one or more computing devices, such as the biometric device 101 of FIG. 1, the biometric system device 105 of FIG. 1, and so on.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is illustrated and described as matching the biometric probe against one or more galleries and/or biometric templates. However, it is understood that this is an example. In various implementations, the match may not be an exact match but may instead match within a matching threshold (such as 0.2%). Various configurations are possible and contemplated without departing from the scope of the present disclosure.

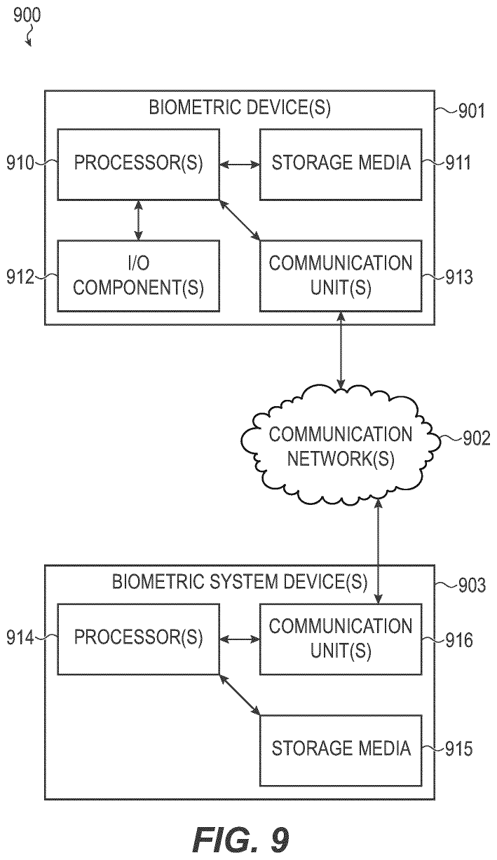

FIG. 9 depicts example relationships between example components that may be used to implement the system 100 of FIG. 1. As shown, one or more biometric devices 901 and one or more biometric system devices 905 may be communicably connected via one or more wired and/or wireless communication networks 9-2.

The biometric system device 905 may store identity information (such as one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like), and so on associated with the identities of people (which may be verified identities, where the identities are verified as corresponding to the particular person named and/or where the identity information is verified as valid). Alternatively and/or additionally, some or all of the health information may be stored separately from the identity information but otherwise associated with the identity information, such as in a Health Insurance Portability and Accountability Act (“HIPAA”) compliant or other data store or enclave. Such a data store or enclave may be stored on one or more different storage media than the identity information, or may be stored on the same storage medium or media and logically isolated from the identity information. The health information may be simultaneously and/or substantially simultaneously accessible as the identity information, such as where the identity information includes a health information identifier or key that may be used to access the separately stored health information. The storage database 709 may control access to the identity information and/or the health information using identification information that is associated with the identity information. The identification information may include digital representations of biometrics and/or other biometric information or biometric data (which may include one or more digital representations of one or more fingerprints, palm prints, blood vessel scans, palm-vein scans, voice prints, facial images, retina images, iris images, deoxyribonucleic acid sequences, heart rhythms, gaits, and so on), one or more logins and/or passwords, authorization tokens, social media and/or other accounts, and so on. In various implementations, the storage database 709 may allow the person associated with an identity to control access to the identity information, the health information, and/or other information (such as payment account information, health information (such as medical records, HIPAA protected information in order to be compliant with various legal restrictions, and so on), contact information, and so on. The storage database 709 may control access to such information according to input received from the person. The server may be operable to communicate with the identification station 707 in order to handle requests to provide the identity information and/or the health information, update and/or otherwise add to the identity information and/or the health information, provide attestations regarding and/or related to the identity information and/or the health information (such as whether or not a person is of a particular age, whether or not a person has a particular license or insurance policy, whether or not a person has been monitored as having particular health information, whether or not a person has had a particular vaccination, whether or not an antibody test evidences that a person has had a particular communicable illness and recovered, whether or not a person has a particular ticket or authorization, whether or not a person has been monitored as having particular antibodies, whether or not a person has been assigned a particular medical diagnosis, and so on), evaluate health information stored in the identity information and/or otherwise associated with the identity information and/or other information stored in the identity information, perform transactions, allow or deny access, route one or more persons, and/or perform one or more other actions.

The biometric device 901 may be any kind of electronic device and/or cloud and/or other computing arrangement. Examples of such devices include, but are not limited to, one or more desktop computing devices, laptop computing devices, mobile computing devices, wearable devices, tablet computing devices, mobile telephones, kiosks and/or other stations, smart phones, printers, displays, vehicles, kitchen appliances, entertainment system devices, digital media players, and so on. The biometric device 901 may include one or more processors 910 and/or other processing units or controllers, communication units 913 (such as one or more network adapters), non-transitory storage media 911 (which may take the form of, but is not limited to, a magnetic storage medium; optical storage medium; magneto-optical storage medium; read only memory; random access memory; erasable programmable memory; flash memory; and so on), input and/or output components 912 (such as one or more displays, speakers, microphones, touch screens, touch pads, track pads, keyboards, mice, one or more health sensors (such as a thermometer and/or other thermal sensor, a blood pressure sensor, a blood test sensor, a blood vessel scanner, a palm-vein scanner, a still image and/or video camera, a 2D and/or 3D image sensor, a saliva sensor, breath sensor, a deoxyribonucleic acid sensor, a heart rhythm monitor, a microphone, sweat sensors, and so on), one or more biometric readers (such as a fingerprint scanner, a blood vessel scanner, a palm-vein scanner, an optical fingerprint scanner, a phosphorescent fingerprint scanner), a camera (which may be a still image and/or video camera), a 2D and/or 3D image sensor, a capacitive sensor, a saliva sensor, a deoxyribonucleic acid sensor, a heart rhythm monitor, a microphone, and so on), and/or other components. The processor 910 may execute one or more sets of instructions stored in the non-transitory storage medium 911 to perform various functions, such as receiving and/or storing digital representations of biometrics and/or other biometric information and/or other identification information, receiving and/or storing identity information and/or health information, matching one or more received digital representations of biometrics and/or other identification information to stored data, retrieving identity information and/or health information associated with stored data matching one or more received digital representations of biometrics and/or other identification information, providing retrieved identity information and/or health information, maintaining one or more galleries, databases, and/or other data stores, communicating with the biometric system device 905 via the communication network 902 using the communication unit 913, and so on. Alternatively and/or additionally, the biometric device 901 may involve one or more memory allocations configured to store at least one executable asset and one or more processor allocations configured to access the one or more memory allocations and execute the at least one executable asset to instantiate one or more processes and/or services, such as one or more gallery management services, biometric identifications services, and so on. Various configurations are possible and contemplated without departing from the scope of the present disclosure.

Similarly, the biometric system device 905 may be any kind of device. The biometric system device 905 may include one or more processors 914 and/or other processing units and/or controllers, one or more non-transitory storage media 915, one or more communication units 916, and/or one or more other components. The processor 914 may execute one or more sets of instructions stored in the non-transitory storage media 915 to perform various functions, such as storing biometric data and/or identity data, providing biometric data and/or identity data, communicating with the biometric device 901 via the communication network 902 using the communication unit 916, and so on. Various configurations are possible and contemplated without departing from the scope of the present disclosure.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., drivers licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

In various implementations, a system may include at least one non-transitory storage medium that stores instructions and at least one processor. The at least one processor may execute the instructions to obtain at least one biometric probe from at least one person; unsuccessfully attempt to match the at least one biometric probe from the at least one person to at least one subset biometric gallery derived from at least one storage biometric gallery; obtain winnowing information; use the winnowing information to obtain biometric data for a group of people associated with the winnowing information in the at least one storage biometric gallery; unsuccessfully attempt to match the at least one biometric probe from the at least one person to the biometric data for the group of people; obtain identity information associated with the at least one person; use the identity information to obtain a biometric template associated with the identity information in the at least one storage biometric gallery; and, upon determining a match within a match threshold between the at least one biometric probe for the at least one person and the biometric template, perform at least one action.

In some examples, the action may include determining to allow the person to enter at least one area. In a number of examples, the action may include operating at least one electronic gate. In various examples, the winnowing information may be obtained from at least one boarding pass, ticket, or identification document. In some examples, the identity information may include at least one of a phone number, an email address, a name, a date of birth, or a barcode. In various examples, the identity information may be used to look up an account associated with the biometric template. In some examples, the group of people may include multiple people. In some examples, the at least one subset biometric gallery may be smaller than the at least one storage biometric gallery and the biometric data for the group of people is smaller than the at least one subset biometric gallery. In a number of examples, the at least one biometric probe may correspond to at least one face.

In some implementations, a system may include at least one non-transitory storage medium that stores instructions and at least one processor. The at least one processor may execute the instructions to obtain image sensor data; determine a largest face included in the image sensor data; determine whether the largest face is live; upon determining that the largest face is live, determine that the largest face is dominant; upon determining that the largest face is live, determine that a next largest face included in the image sensor data that is live is the dominant; and perform at least one action using the dominant.

In various examples, the at least one action may include generating at least one biometric probe for the dominant and performing at least one biometric comparison using the at least one biometric probe. In some examples, the at least one action may include overlaying at least one reticle corresponding to the dominant in the image sensor data and displaying the image sensor data with the at least one reticle. In various such examples, the at least one action may further include tracking the dominant in subsequent image sensor data, updating the at least one reticle for movement of the dominant in the subsequent image sensor data to generate at least one updated reticle, and displaying the subsequent image sensor data with the updated at least one reticle.

In some examples, the at least one action may include performing at least one of exposure control or gain control on the dominant in the image sensor data. In a number of such examples, the at least one action may further include omitting performing the at least one of the exposure control or the gain control on portions of the image sensor data other than the dominant in the image sensor data. In various such examples, performing the at least one of the exposure control or the gain control on the dominant in the image sensor data may include generating at least one box around the dominant and performing the at least one of the exposure control or the gain control on an area of the image sensor data within the at least one box.

In a number of implementations, a method may include determining a dominant by determining a largest, live face included in image sensor data; generating at least one biometric probe for the dominant; unsuccessfully attempting to match the at least one biometric probe from the at least one person to at least one subset biometric gallery derived from at least one storage biometric gallery; using winnowing information to obtain biometric data for a group of people associated with the winnowing information in the at least one storage biometric gallery; unsuccessfully attempting to match the at least one biometric probe to the biometric data for the group of people; using the identity information to obtain a biometric template associated with the identity information in the at least one storage biometric gallery; and upon determining a correspondence between the at least one biometric probe and the biometric template, performing at least one action.

In various examples, the method may further include obtaining the image sensor data using at least one application specific processor of at least one camera. In some examples, the group may be empty. In a number of examples, the method may further include upon determining that the at least one biometric probe and the biometric template do not match, perform at least one alternative action.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to enhancements for low-touch biometric systems. In various embodiments, winnowing information is obtained when a biometric probe unsuccessfully matches against a subset gallery. The winnowing information is used to obtain biometric data from an associated group of people and the biometric probe is then compared against the biometric data. If this also fails, identity information may be obtained and used to obtain a corresponding biometric template to match the biometric probe against. In some embodiments, a dominant may be determined by selecting the largest live face in an image then performing one or more actions using the dominant. Such one or more actions may include selecting the dominant for capture, performing exposure control and/or gain control on the dominant as opposed to the rest of an image, determining guidance to provide for biometric capture based at least on a position of the dominant, providing such guidance, and so on.

The present disclosure recognizes that biometric and/or other personal data is owned by the person from whom such biometric and/or other personal data is derived. This data can be used for the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensure that others with access to the biometric and/or other personal data adhere to the same privacy policies and practices. Further, such entities should certify their adherence to widely accepted privacy policies and practices by subjecting themselves to appropriate third party evaluations.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
at least one non-transitory storage medium that stores instructions; and
at least one processor that executes the instructions to:
obtain at least one biometric probe from at least one person;
unsuccessfully attempt to match the at least one biometric probe from the at least one person to at least one subset biometric gallery derived from at least one storage biometric gallery;
obtain winnowing information;
use the winnowing information to obtain biometric data for a group of people associated with the winnowing information in the at least one storage biometric gallery;
unsuccessfully attempt to match the at least one biometric probe from the at least one person to the biometric data for the group of people;
obtain identity information associated with the at least one person;
use the identity information to obtain a biometric template associated with the identity information in the at least one storage biometric gallery; and
upon determining a match within a match threshold between the at least one biometric probe for the at least one person and the biometric template, perform at least one action.

2. The system of claim 1, wherein the action comprises determining to allow the person to enter at least one area.

3. The system of claim 1, wherein the action comprises operating at least one electronic gate.

4. The system of claim 1, wherein the winnowing information is obtained from at least one boarding pass, ticket, or identification document.

5. The system of claim 1, wherein the identity information comprises at least one of a phone number, an email address, a name, a date of birth, or a barcode.

6. The system of claim 1, wherein the identity information is used to look up an account associated with the biometric template.

7. The system of claim 1, wherein the group of people includes multiple people.

8. The system of claim 1, wherein:
the at least one subset biometric gallery is smaller than the at least one storage biometric gallery; and
the biometric data for the group of people is smaller than the at least one subset biometric gallery.

9. The system of claim 1, wherein the at least one biometric probe corresponds to at least one face.

10. A system, comprising:
at least one non-transitory storage medium that stores instructions; and
at least one processor that executes the instructions to:
obtain image sensor data;
determine a largest face included in the image sensor data;
determine whether the largest face is live;
upon determining that the largest face is live, determine that the largest face is dominant;
upon determining that the largest face is live;
determining that a next largest face included in the image sensor data that is live is the dominant; and
performing at least one action using the dominant.

11. The system of claim 10, wherein the at least one action comprises:
generating at least one biometric probe for the dominant; and
performing at least one biometric comparison using the at least one biometric probe.

12. The system of claim 10, wherein the at least one action comprises:
overlaying at least one reticle corresponding to the dominant in the image sensor data; and
displaying the image sensor data with the at least one reticle.

13. The system of claim 12, wherein the at least one action further comprises:
tracking the dominant in subsequent image sensor data;
updating the at least one reticle for movement of the dominant in the subsequent image sensor data to generate at least one updated reticle; and
displaying the subsequent image sensor data with the updated at least one reticle.

14. The system of claim 10, wherein the at least one action comprises performing at least one of exposure control or gain control on the dominant in the image sensor data.

15. The system of claim 14, wherein the at least one action further comprises omitting performing the at least one of the exposure control or the gain control on portions of the image sensor data other than the dominant in the image sensor data.

16. The system of claim 14, wherein performing the at least one of the exposure control or the gain control on the dominant in the image sensor data comprises:
generating at least one box around the dominant; and
performing the at least one of the exposure control or the gain control on an area of the image sensor data within the at least one box.

17. A method, comprising:
determining a dominant by determining a largest, live face included in image sensor data;
generating at least one biometric probe for the dominant;
unsuccessfully attempting to match the at least one biometric probe from the at least one person to at least one subset biometric gallery derived from at least one storage biometric gallery;
using winnowing information to obtain biometric data for a group of people associated with the winnowing information in the at least one storage biometric gallery;
unsuccessfully attempting to match the at least one biometric probe to the biometric data for the group of people;
using the identity information to obtain a biometric template associated with the identity information in the at least one storage biometric gallery; and
upon determining a correspondence between the at least one biometric probe and the biometric template, perform at least one action.

18. The method of claim 17, further comprising obtaining the image sensor data using at least one application specific processor of at least one camera.

19. The method of claim 17, wherein the group is empty.

20. The method of claim 17, further comprising upon determining that the at least one biometric probe and the biometric template do not match, perform at least one alternative action.
